(19) United States
(12) Patent Application Publication
(10) Pub. No.: US 2022/0018558 A1
(43) Pub. Date: Jan. 20, 2022

(54) SYSTEM AND METHOD OF A PANEL ASSEMBLY FOR AIR TREATMENT

(71) Applicants: Louis J. Blaiotta, Rye Brook, NY (US); Edward Thomas Bosco, Chappaqua, NY (US)

(72) Inventors: Louis J. Blaiotta, Rye Brook, NY (US); Edward Thomas Bosco, Chappaqua, NY (US)

(73) Assignee: Columbia Elevator Products Company, Inc.

(21) Appl. No.: 17/373,060

(22) Filed: Jul. 12, 2021

Related U.S. Application Data
(60) Provisional application No. 63/051,618, filed on Jul. 14, 2020.

(51) Int. Cl. F24F 8/22; F24F 8/30; F24F 13/20; F24F 13/28; F24F 13/14; B66B 11/02

(52) U.S. Cl. CPC F24F 8/22; F24F 8/30; F24F 13/20; F24F 2013/205; F24F 13/14; B66B 11/024; F24F 13/28

(57) ABSTRACT

A panel assembly for air treatment comprising a rigid body including an inner surface and an outer surface that is opposite the inner surface, the inner surface defining an inner space within the rigid body, the rigid body having a rectangular shape with a ratio of a width to a depth such that the rigid body is flat and hollow, the rigid body including a first longitudinal end containing a first opening in communication with the inner space and a second longitudinal end containing a second opening in communication with the inner space, the first opening positioned opposite the second opening along a longitudinal length, and an ultra-violet light assembly mounted within the inner space.

### CROSS-REFERENCE TO RELATED APPLICATIONS

This application claim priority to U.S. provisional patent application Ser. No. 63/051,618, titled “A System and Method of a Panel Assembly for Air Treatment,” and filed on Jul. 14, 2020, which is hereby incorporated by reference herein in its entirety.

### FIELD OF THE INVENTION

This application relates to an air treatment system and, more specifically, a system and method for a panel assembly for air treatment.

### BACKGROUND

The Coronavirus pandemic has created a new awareness of the risk of airborne disease transmission. Travel in an elevator is essential to the operation of a high-rise building, but the trip assembles a high density, uncontrolled occupancy group in a nominally sealed elevator cab, which increases risk. The congested conditions in an elevator cab require that any solution that impacts airflow patterns provides a predictable airflow path to avoid blowing airborne pathogens from one occupant towards another. The short duration of an elevator trip means that any solution needs to operate quickly.

What is needed is an air treatment system that leverages the construction details of the elevator cab to optimize the pathogen inactivation effect of ultraviolet light while protecting the elevator cab occupants from direct exposure to the ultraviolet lamps, all without reducing the cab interior space. What is further needed is an air treatment system that has applications outside of an elevator where control of airborne pathogen spread is required, but space for mitigation equipment is limited.

It is the primary objective to provide an air treatment system that may be installed into an enclosed and confined space. In some embodiments, the enclosed and confined space may be an elevator cab or the elevator lobby immediately adjacent and contiguous to the elevator entrance to the elevator cab. The panel may be retrofitted into existing elevator instances or incorporated into the cab-front or wall-enclosure systems of new elevator installations.

### SUMMARY

An embodiment of a panel assembly for air treatment is provided. The panel assembly for air treatment including a rigid body including an inner surface and an outer surface that is opposite the inner surface, the inner surface defining an inner space within the rigid body, the rigid body having a rectangular shape with a ratio of a length to a depth such that the rigid body is flat and hollow. The rigid body includes a first longitudinal end containing a first opening in communication with the inner space and a second longitudinal end containing a second opening in communication with the inner space. The first opening is positioned opposite the second opening along the longitudinal length. The panel assembly for air treatment further including a base assembly mounted at the first opening and in communication with the inner space, the base assembly including a plurality of openings that allows air to enter the inner space, a fan assembly mounted proximate the second opening, and in communication with the inner space, an ultra-violet light assembly mounted within the inner space and positioned in-between the fan assembly and the base assembly, and the fan assembly creating a negative air pressure at the second opening relative to the first opening, the negative air pressure creating an airflow entering the rigid body through the base assembly and exiting the rigid body through the fan assembly, the airflow passing over the ultra-violet light assembly within the inner space and exiting the inner space as a treated airflow.

### BRIEF DESCRIPTION OF THE DRAWINGS

The drawings described below are for illustrative purposes only and are not necessarily drawn to scale. The drawings are not intended to limit the scope of the disclosure in any way. Wherever possible, the same or like reference numbers are used throughout the drawings to refer to the same or like parts.

FIG. 1 is a perspective view of a panel assembly for air treatment according to the embodiments disclosed herein.

FIG. 2 is a perspective view of an inner space defined within a panel assembly for air treatment according to the embodiments disclosed herein.

FIG. 3 is a perspective view of an air conduit assembly for a panel assembly for air treatment according to the embodiments disclosed herein.

FIG. 4 is a perspective view of an air dispersal assembly for a panel assembly for air treatment according to the embodiments disclosed herein.

FIG. 5 is a perspective view of a panel assembly for air treatment within an elevator cab according to the embodiments disclosed herein.

### DETAILED DESCRIPTION

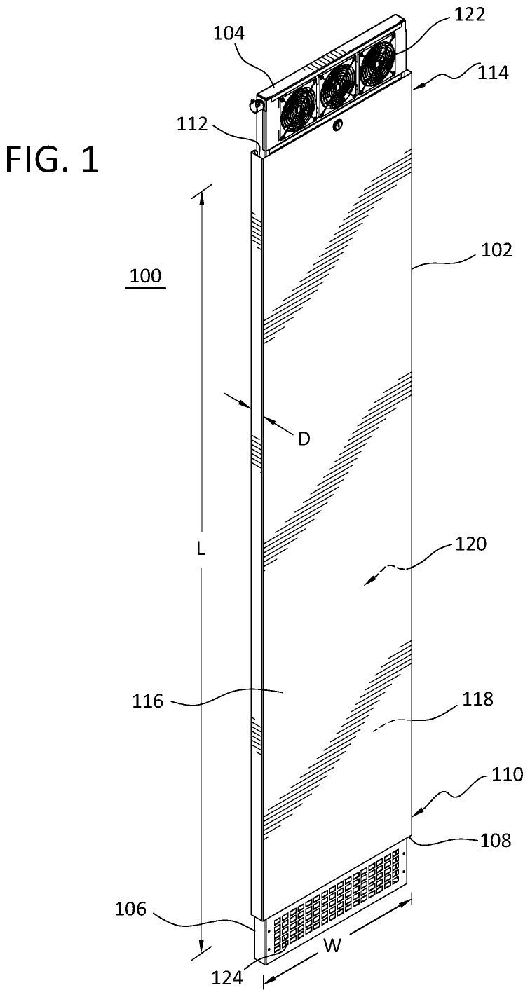

Described herein are various embodiments of a system and supporting methods for a panel assembly for air treatment within a closed space such as an elevator cab. FIG. 1 is a perspective view of a panel assembly for air treatment 100 according to the embodiments disclosed herein. The panel assembly for air treatment 100 may include a rigid body 102, a fan assembly 104, and a base assembly 106.

The rigid body 102 may be generally rectangular shaped with a first opening 108 at a first longitudinal end 110 and a second opening 112 at a second longitudinal end 114. The second longitudinal end 114 being opposite the first longitudinal end 110.

The dimensions of the rigid body 102 are defined by a length L, a width W, and a depth D. The rectangular shape of the rigid body 102 may have a ratio of the width W to the depth D such that the rigid body 102 is flat and hollow.

For example, the ratio of the width W to the depth D may be at least four (4) to one (1), ensuring that the rigid body is flat and hollow with a generally rectangular shape.

The rigid body 102 may include an outer surface 116 and an inner surface 118 opposite the outer surface 116. The inner surface 118 may define an inner space 120 within the hollow portion of the rigid body 102. The first opening 108 and the second opening 112 are each in communication with and provide access to the inner space 120.

The rigid body 102 may be composed of any rigid material capable of maintaining the generally rectangular shape of the rigid body 102 and effectively isolating the inner space 120. Including aluminum, steel, plastic, or any material known to one of ordinary skill in the art.

The fan assembly 104 may be positioned proximate to the second longitudinal end 114 as to be in communication with the second opening 112.

In one embodiment, as shown in FIG. 1, the fan assembly 104 may be coupled directly to the rigid body 102 at the second longitudinal end 114 such that the fan assembly 104 abuts the second opening 112 and is in communication with the inner space 120.

Alternatively, in another embodiment, the fan assembly 104 may be coupled indirectly to the rigid body 102 at the second longitudinal end 114. Specifically, the fan assembly 104 may be removed from the second opening 112 while remaining in communication with the inner space 120 via some form of airtight connection between the fan assembly 104 and the second opening 112.

The fan assembly 104 may be comprised of a plurality of individual fans 122 arranged to create a negative air pressure at the second opening 112. The negate air pressure created at the second opening 112 has the effect of pulling air out of the inner space 120 through the second opening 112. The individual fans 122 may be of fixed speed type to create a negative air pressure at the second opening 112 that does not vary. In one embodiment, the individual fans 122 of a fixed-speed type may be configured to provide negative pressure at the second opening 112 that is sufficient to ensure a minimum of 40 air changes per hour (ACH) within a defined space, such as within a standard elevator cab with industry-standard dimensions.

Alternatively, the individual fans may be of a variable speed type create a negative air pressure at the second opening 112 that may be varied. The varied negative air pressure may provide for adjusting the minimum air changes per hour (ACH) within defined spaces of varying dimensions.

The base assembly may be positioned proximate to the first longitudinal end 110 and in communication with the first opening 108.

As shown in FIG. 1, in one embodiment, the base assembly 106 may be coupled directly to the rigid body 102 at the first longitudinal end 110.

Alternatively, in another embodiment, the base assembly 106 may be coupled indirectly to the rigid body 102 at the first longitudinal end 110. Specifically, the base assembly 106 may be removed from the first opening 108 while remaining in communication with the inner space 120 via an airtight connection between the base assembly 106 and the first opening 108.

The base assembly 106 may include a plurality of openings 124 through which surrounding air may be pulled into the enter the rigid body 102 for air treatment.

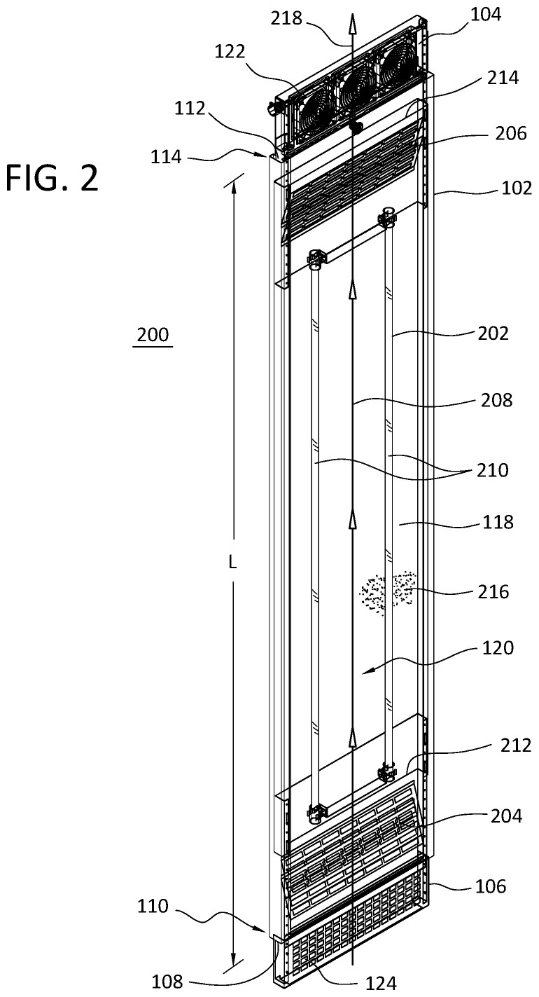

FIG. 2 is a perspective view 200 showing an inner space 120 defined within a rigid body 102 of a panel assembly for air treatment according to the embodiments disclosed herein.

The inner space 120 may include an ultra-violet light assembly 202, a first louver assembly 204, and a second louver assembly 206.

The ultra-violet light assembly 202 may be positioned between the fan assembly 104 and the base assembly 106 within the inner space 120 of the rigid body 102.

The ultra-violet light assembly 202 generates short-wavelength ultra-violet light, namely ultra-violet C. The ultra-violet light assembly 202 may be comprised of one or more individual ultra-violet bulbs 210 extending along the length L of the inner space 120. The benefits of using more than one of the individual ultra-violet bulbs 210 may include reliability, effectiveness, and the ability to scale.

As discussed above, an airflow 208 is created and flows through the inner space 120 of the rigid body 102 due to the negative air pressure created by the fan assembly 104 at the second opening 112. The airflow 208 is comprised of air originating from the area surrounding the panel assembly for air treatment 100. The surrounding air is drawn into the inner space 120 through the plurality of openings 124 in the base assembly 106 at the first opening 108. Once within the inner space 120, the airflow 208 flows over the entire length of the ultra-violet light assembly 202. Once passed the ultra-violet light assembly 202, the airflow 208 is drawn out of the inner space 120 through the second opening 112 by the fan assembly 104.

While within the inner space 120, the airflow 208 is exposed to the ultra-violet light emitted by the plurality of individual ultra-violet bulbs 210. The airflow 208 then exits the inner space 120 through the second opening 112 as a treated airflow 218.

The first louver assembly 204 may be positioned within the inner space 120 of the rigid body 102 in-between the ultra-violet light assembly 202 and the first opening 108. Similarly, the second louver assembly 206 may be positioned within the inner space 120 in-between the ultra-violet light assembly 202 and the second opening 112. The first and second louver assemblies 204, 206 are designed to allow the airflow 208 to flow unrestricted while preventing any light emitted from the individual ultra-violet bulbs 210 to escape through the first and second openings 108, 112.

The rigid body 102 may further include a first air filter assembly 212 and a second air filter assembly 214. The first air filter assembly 212 may be positioned within the inner space 120 of the rigid body 102 in-between the ultra-violet light assembly 202 and the first opening 108. Similarly, the second air filter assembly 214 may be positioned within the inner space 120 in-between the ultra-violet light assembly 202 and the second opening 112.

Alternatively, the second air filter assembly 214 may be positioned outside the inner space 120 after the discharge of the airflow from the fan assembly at the second opening 112.

The first and second air filter assemblies 212, 214 may each include a high-performance air filter, including a minimum efficiency reporting value (MERV) air filter, a high efficiency particulate air filter, a fireproof metal filter, a combination thereof, or any other filter known to one of ordinary skill in the art.

The inner surface 118 of rigid body 102 may include a coating 216. The coating 216 may be of a type that is catalyzed by light emitted from the ultra-violet light assembly 202 to produce airborne sanitizing ions. The sanitizing ions may interact with the airflow 208 to further treat the airflow 208.

The coating 216 may also reflect light to effectively distribute the light emitted from the ultra-violet light assembly 202 across the airflow 208.

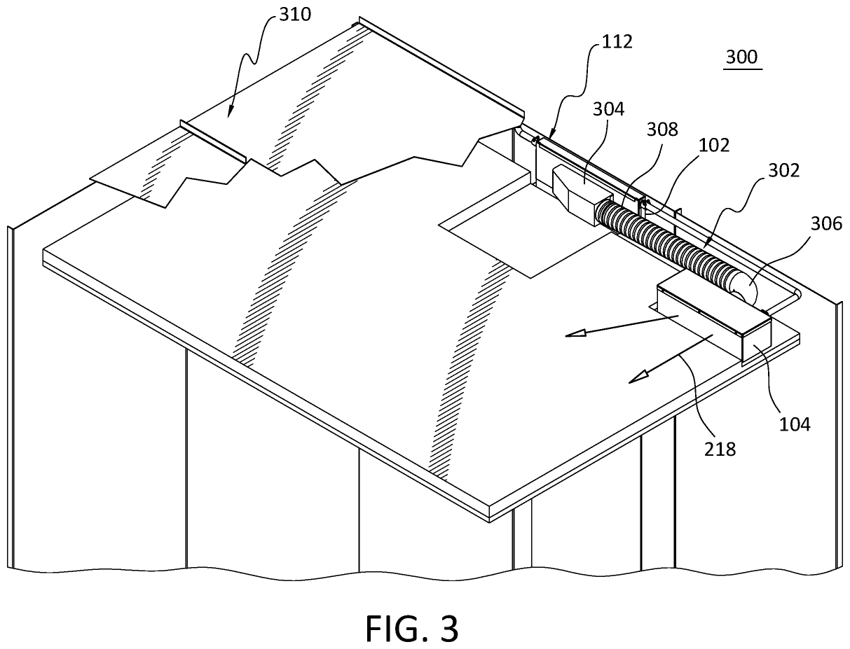

FIG. 3 is a perspective view 300 of an air conduit assembly 302 for a panel assembly for air treatment 100 according to the embodiments disclosed herein.

The air conduit assembly 302 may provide for an airtight connection between the second opening 112 of the rigid body 102 and the fan assembly 104. With the addition of the air conduit assembly 302, the fan assembly 104 may be removed from the second opening 112 while maintaining and routing the airflow 208 as it flows out of the second opening 112. The air conduit assembly 302 may be comprised of a rigid body interface 304, a fan assembly interface 306, and a flexible conduit 308. As shown in FIG. 3, the air conduit assembly 302 may allow for the effective installation of the panel assembly for air treatment 100 into an existing structure such as an elevator cab 310 that is already in operation.

The rigid body interface 304 may provide for an airtight connection between the air conduit assembly 302 and the second opening 112 of the rigid body 102. Similarly, the fan assembly interface 306 may provide for an airtight connection between the air conduit assembly 302 and the fan assembly 104. Lastly, the flexible conduit 308 may provide for a flexible and airtight connection between the rigid body interface 304 and the fan assembly interface 306.

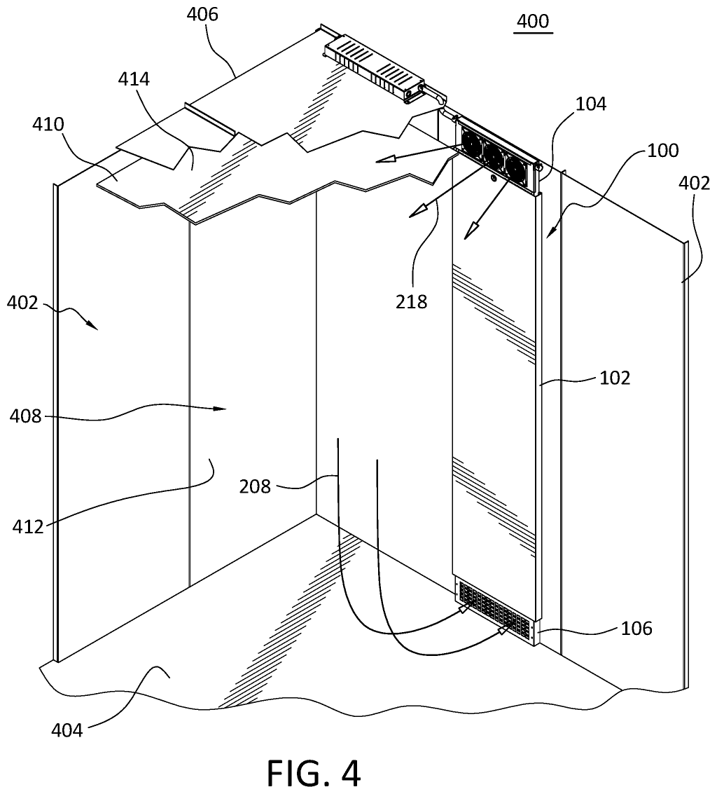

FIG. 4 is a perspective view of a panel assembly for air treatment 100 within an elevator cab 400 according to the embodiments disclosed herein. The elevator cab 400 may include a plurality of elevator cab walls 402, a floor 404, and a canopy 406 that together define an inner cab space 408. The elevator cab 400 may further include a suspended ceiling 410 positioned below the canopy 406. The suspended ceiling 410 in combination with floor 404 and the plurality of walls 402 may define a primary inner cab space 412. The canopy 406, the suspended ceiling 410, and the walls 402 may define a secondary inner cab space 414.

The panel assembly for air treatment 100 may be secured to any one of the plurality of walls 402 within the elevator cab 400, including the wall containing cab-front(s) (not shown) where the elevator doorway(s) is located. The panel assembly for air treatment 100 may be secured to maintain the integrity of the inner space 120 within the rigid body 102. As such, the panel assembly for air treatment 100 may be secured to any one of the plurality walls 402 in any reasonable manner known to one of ordinary skill in the art.

As shown in FIG. 4, the panel assembly for air treatment 100 is secured within the inner cab space 408 such that the base assembly 106 and the rigid body 102 are positioned within the primary inner cab space 412, and the fan assembly 104 is positioned within the secondary inner cab space 414.

The airflow 208 is drawn from the primary inner cab space 412 and into the rigid body 102 through the base assembly 106. Once within the inner space 120 of the rigid body 102, the airflow is treated by the ultra-violet light assembly 202 and the first and second air filter assemblies 212, 214 as it is drawn from the base assembly 106 towards the fan assembly 104.

The treated airflow 218 then exists from the fan assembly 104 into the secondary inner cab space 414. Once within the secondary inner cab space 414, the treated airflow 218 flows down into the primary inner cab space 412. Eventually, the treated airflow 218 becomes integrated into the airflow 208 that is drawn into the inner space 120 through the base assembly 106.

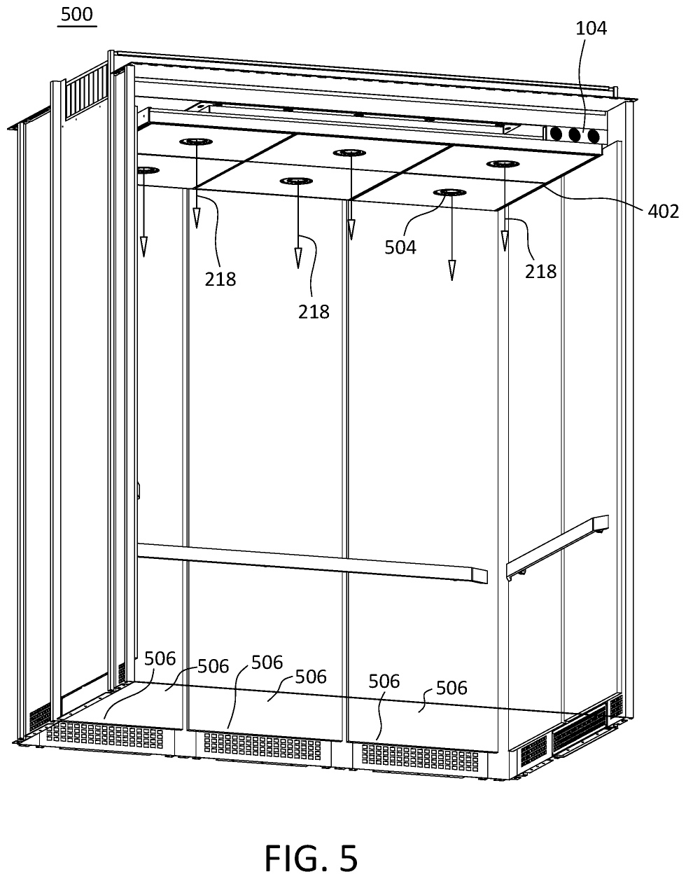

FIG. 5 is a perspective view of an air dispersal assembly 502 for a panel assembly for air treatment 100 within an elevator cab 500 according to the embodiments disclosed herein. An air dispersal assembly 502 may function as the suspended ceiling within the elevator cab 500. The air dispersal assembly 502 may be in communication with the fan assembly 104 to receive the treated airflow 218 flowing out of the fan assembly 104.

The air dispersal assembly 502 may include a plurality of openings 504 through which the treated airflow 218 may be guided and then dispersed. The plurality of openings 504 may be arranged in a pattern that creates distinct positive pressure zones 506 in an area below the air dispersal assembly 502 and adjacent to the base assembly 106. The airflow 218 through the rigid body 102 recycles air within an elevator cab without a substantial introduction of air from outside the elevator cab 500.

The foregoing description discloses only example embodiments. Modifications of the above-disclosed assemblies and methods which fall within the scope of this disclosure will be readily apparent to those of ordinary skill in the art.

This disclosure is not intended to limit the invention to the particular assemblies and/or methods disclosed, but, to the contrary, the intention is to cover all modifications, equivalents, and alternatives falling within the scope of the claims.

What is claimed is:

1. A panel assembly for air treatment comprising:
a rigid body including an inner surface and an outer surface that is opposite the inner surface, the inner surface defining an inner space within the rigid body;
the rigid body having a rectangular shape with a ratio of a width to a depth such that the rigid body is flat and hollow;
the rigid body including a first longitudinal end containing a first opening in communication with the inner space and a second longitudinal end containing a second opening in communication with the inner space, the first opening positioned opposite the second opening along a longitudinal length;
a base assembly mounted at the first opening and in communication with the inner space, the base assembly including a plurality of openings that allows air to enter the inner space;
a fan assembly mounted proximate to the second opening and in communication with the inner space;
an ultra-violet light assembly mounted within the inner space and positioned in-between the fan assembly and the base assembly; and
the fan assembly creating a negative air pressure at the second opening relative to the first opening, the negative air pressure creating an airflow entering the rigid body through the base assembly and exiting the rigid body through the fan assembly, the airflow passing over the ultra-violet light assembly within the inner space and exiting the inner space as a treated airflow.

2. The panel assembly for air treatment of claim 1, wherein the ratio of the width to the depth, is at least 4:1.

3. The panel assembly for air treatment of claim 1, further comprising an air conduit assembly connecting the fan assembly to the second opening of the rigid body.

4. The panel assembly for air treatment of claim 3, wherein the airflow through the rigid body recycles air within an elevator cab without a substantial introduction of air from outside the elevator cab.

5. The panel assembly for air treatment of claim 4, wherein the fan assembly provides a minimum of 40 air changes per hour (ACH) within the elevator cab.

6. The panel assembly for air treatment of claim 3, wherein the rigid body is embedded within one of a plurality of elevator cab walls comprising the elevator cab.

7. The panel assembly for air treatment of claim 1, further comprising:
an air dispersal assembly in communication with the treated airflow, the air dispersal assembly including a plurality of openings through which the treated airflow is dispersed, the plurality of openings arranged in a pattern that creates distinct positive pressure zones below the air dispersal assembly.

8. The panel assembly for air treatment of claim 1, further comprising:
a first louver assembly mounted within the inner space between the ultra-violet light assembly and the first opening, the first louver assembly blocking light from the ultra-violet light assembly from emanating out of the first opening while allowing the airflow to flow unrestricted; and
a second louver assembly mounted within the inner space between the ultra-violet light assembly and the second opening, the second louver assembly blocking light from the ultra-violet light assembly from emanating out of the second opening while allowing the airflow to flow unrestricted.

9. The panel assembly for air treatment of claim 1, further comprising:
a first filter assembly mounted within the inner space and positioned in-between the ultra-violet light assembly and the first opening; and
a second filter assembly mounted within the inner space and positioned in-between the ultra-violet light assembly and the second opening or positioned after the fan assembly.

10. The panel assembly for air treatment of claim 8, wherein the first filter assembly and the second filter assembly each include a high-performance air filter.

11. The panel assembly for air treatment of claim 1, wherein the inner surface includes a coating that may be catalyzed to produce airborne sanitizing ions because of light emanating from the ultra-violet light assembly.

12. The panel assembly for air treatment of claim 1, wherein the inner surface includes a coating that may distribute light emanating from the ultra-violet light assembly evenly across the airflow within the inner space.

13. The panel assembly for air treatment of claim 1, wherein the ultra-violet light assembly generates short-wavelength ultra-violet light, namely ultra-violet C.

14. The panel assembly for air treatment of claim 1, wherein the base assembly includes a plurality of openings through which the airflow enters the inner space.

15. A method of manufacturing a panel assembly for air treatment, the method including the steps:
providing a rigid body including an inner surface and an outer surface opposite the inner surface, the inner surface defining an inner space within the rigid body;
the rigid body having a rectangular shape with a ratio of a length to a depth such that the rigid body is flat and hollow;
the rigid body including a first longitudinal end containing a first opening in communication with the inner space and a second longitudinal end containing a second opening in communication with the inner space, the first opening positioned opposite the second opening along a longitudinal length;
providing a base assembly mounted at the first opening and in communication with the inner space;
providing a fan assembly mounted proximate the second opening and in communication with the inner space;
providing an ultra-violet light assembly mounted within the inner space and positioned in-between the fan assembly and the base assembly; and
the fan assembly creating a negative air pressure at the second opening relative to the first opening, the negative air pressure creating an airflow passing over the ultra-violet light assembly within the inner space and existing the inner space as a treated airflow.
